(19) United States
(12) Patent Application Publication
(10) Pub. No.: US 2026/0261873 A1
(43) Pub. Date: Sep. 3, 2026

(54) OBSERVABILITY VALIDATION OF A NETWORK FUNCTION IN AN OPEN RADIO ACCESS NETWORK (O-RAN) WITH AN OCCURRENCE OF AN ISSUE ASSOCIATED WITH OBSERVABILITY REPORTING

(71) Applicant: DISH Wireless L.L.C., Englewood, CO (US)

(72) Inventor: Manish Uniyal, Parker, CO (US)

(21) Appl. No.: 19/066,604

(22) Filed: Feb. 28, 2025

(51) Int. Cl. H04W 24/02

(52) U.S. Cl. CPC H04W 24/02

(57) ABSTRACT

Technologies for observability validation in an open radio access network (O-RAN) of a cellular network are described. One method include receiving a notification of an occurrence of an issue associated with observability reporting in the cellular network; responsive to receiving the notification, retrieving data associated with transmissions in the cellular network; determining whether at least one transmission in the data is incomplete; and sending a validation result based on the determining.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. However, handling certain issues in a 5G NR cellular network can be improved to facilitate such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing observability validation in an open radio access network (O-RAN) with an occurrence of an issue associated with observability reporting according to at least one embodiment.

FIG. 2 is a block diagram of a system including a validation component that implements observability validation in an O-RAN with an occurrence of an issue associated with observability reporting according to at least one embodiment.

FIGS. 3 and 4 are flow diagrams of example methods of implementing observability validation in an O-RAN with an occurrence of an issue associated with observability reporting according to at least one embodiment.

FIG. 5 is a block diagram of an example computer system in which embodiments of the present disclosure can operate.

### DETAILED DESCRIPTION

Technologies for observability validation in an open radio access network (O-RAN) in a telecommunications network, such as a cellular network (e.g., 5G wireless network, 6G wireless network) with an occurrence of an issue associated with observability reporting are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Observability refers to operators’ visibility into the performance of various network elements in a network, which allows the network to achieve enhanced performance and optimized resource allocation. In some cases, observability may be achieved by implementing a component that monitors a set of key performance indicators (KPIs) of network elements (e.g., distributed unit (DU), centralized unit (CU)), and the component can be specific to a vendor. Multiple vendors may use different sets of KPIs and generate vendor-specific reports regarding the KPIs. In the case of an issue occurring during monitoring or reporting the KPIs, the status of the network, as supposed to be reflected by the KPIs, may be unknown. Because the status of the network is unknown, the impact on user of the network due to the issue is also unknown. Therefore, the operators may lack information to determine how to respond to the issue.

Aspects and embodiments of the present disclosure address the above and other deficiencies by providing a system that implements observability validation in an open radio access network (O-RAN) of a cellular network. The observability validation refers to validating whether an issue associated with the observability reporting has an impact on one or more users. For example, such issue may include issue with source data due to the system error, issue with element management system (EMS) itself, EMS connectivity issue, reporting issue, data flow pipeline issue (in the case of O-RAN and cloud network), intermittent data flow issue (e.g., data flow from EMS to network monitoring tool), etc.

Specifically, a component of the cellular network (e.g., validation component) may receive a notification from a KPI monitoring component of the cellular network (e.g., vendor-specific EMS or performance monitoring tool), where the notification indicates an occurrence of an issue associated with the observability reporting. For example, the KPI monitoring component may detect a failure in the real-time retrieving of the monitored data or may be unable to generate a periodically-generated KPI report due to missing data of certain KPIs. In response, the KPI monitoring component may generate the notification described above and send it to the component of the cellular network (e.g., validation component). Upon receiving the notification, the component of the cellular network (e.g., validation component) may automatically trigger an observability validation process, where the observability validation process determines whether there exists an impact to one or more users (“user impact”) caused by the issue associated with the observability reporting. The user impact may refer to the impact on the service(s) provided by the network to the user(s).

In some implementations, the component of the cellular network (e.g., validation component) may implement the observability validation process by retrieving call trace data and determining whether one or more transmissions in the call trace data is incomplete. A call trace may represent a collection of transactions that represent a unique user or API transaction that is handled by an application and its constituent services. For example, when a user equipment (UE) sends an initial request to the network, a trace identifier may be assigned to a collection of data associated with each operation performed for responding and completing the initial request. In some implementations, the validation component may use end-to-end tracing tool or call-cause code viewer tool to obtain call trace data. In some implementations, the validation component may determine whether at least one transaction toward a UE in the call trace data is incomplete (e.g., reflected by a flag, or a bit field). In some implementations, responsive to determining that at least one transaction toward a UE in the call trace data is incomplete, the validation component may determine that there exists an impact to one or more users caused by the issue associated with the observability reporting. In some implementations, responsive to determining that no transaction toward a UE in the call trace data is incomplete, the validation component may determine that there exists no impact to one or more users caused by the issue associated with the observability reporting.

In some implementations, the component of the cellular network (e.g., validation component) may implement the observability validation process by retrieving call flow log and determining whether one or more transmissions in the call flow log is incomplete. A call flow may represent a set of ordered message transmissions between UE and base station, including cell search, downlink synchronization, uplink synchronization, radio resource control (RRC) connection request, RRC setup, and RRC setup complete, which are described in detail below. In some implementations, the validation component may download the packet capability (PCap) log file of a network element (e.g., CU or DU) to obtain call flow log. In some implementations, the validation component may determine whether at least one RRC setup complete message in the call flow log is specified as incomplete (e.g., reflected by a flag, or a bit field). In some implementations, responsive to determining that at least one RRC setup complete message in the call flow log is specified as incomplete, the validation component may determine that there exists an impact to one or more users caused by the issue associated with the observability reporting. In some implementations, responsive to determining that no RRC setup complete message in the call flow log is specified as incomplete, the validation component may determine that there exists no impact to one or more users caused by the issue associated with the observability reporting.

Upon determining whether there exists an impact to one or more users caused by the issue associated with the observability reporting, the component of the cellular network (e.g., validation component) may send a validation result based on the determination to a corresponding component of the cellular network. In some implementations, responsive to determining that there exists an impact to one or more users caused by the issue associated with the observability reporting, the validation result may indicate that an action is required to mitigate or fix the issue associated with the observability reporting. In some implementations, responsive to determining that there exists no impact to one or more users caused by the issue associated with the observability reporting, the validation result may indicate that the issue associated with the observability reporting is a reporting issue.

Aspects and embodiments of the present disclosure can effectively check the impact on users or customers when monitoring the cellular network encounters issues such that certain status of network elements in the cellular network is unknown. Aspects and embodiments of the present disclosure can improve system performance and cost-efficiency by providing suitable solutions to the issue depending on whether the issue impacts on users or customers or not. It may provide the efficient view to the monitoring team in case of the observability scenarios such as when EMS is not reporting KPI for network functions, and may also provide faster solution and efficiency in solving such issues in O-RAN.

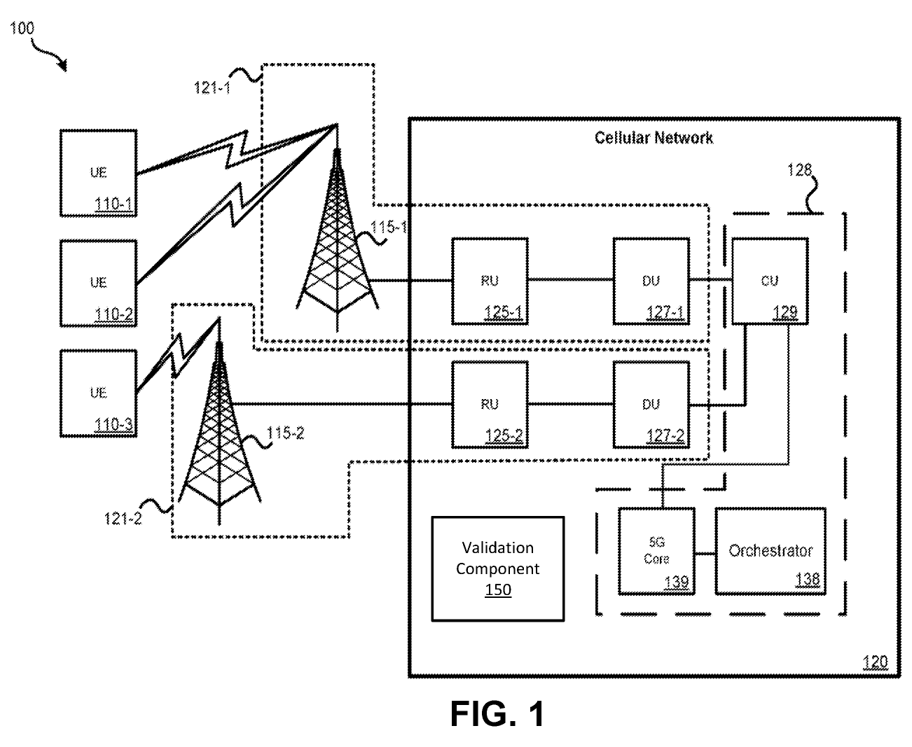

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating updating and removing protocol data unit (PDU) sessions, and managing session context with the user plane function (UPF) (e.g., manage UE context and network handovers between base stations).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client’s or user’s point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

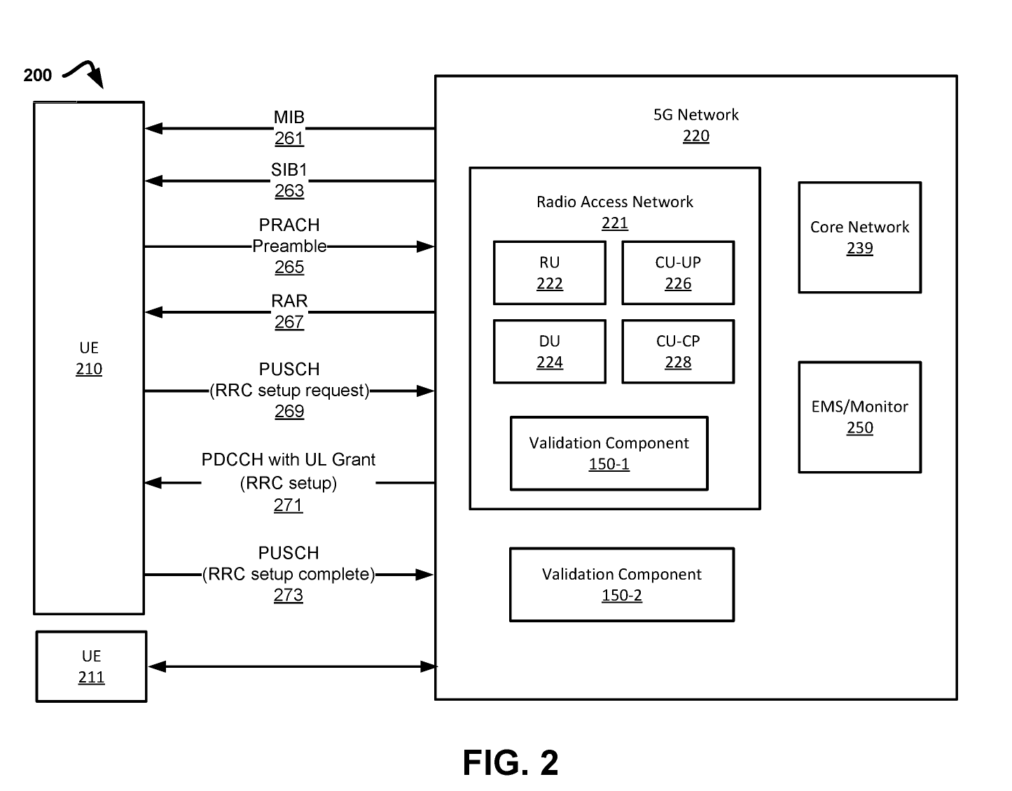

In some embodiments, the cellular network 120 includes a validation component 150 that implements observability validation in an open radio access network (O-RAN) of a cellular network. In some embodiments, the validation component 150 is part of the base station(s). Further details regarding the operations of the validation component 150 are described below with reference to FIGS. 2-5.

FIG. 2 is a block diagram of example validation component according to at least one embodiment. Referring to FIG. 2, a 5G network 220 includes a radio access network (RAN) 221 and a core network 239 according to at least one embodiment. In at least one embodiment, the 5G network 220 includes the validation component 150-2. In at least one embodiment, the validation component 150-1 can be implemented in the RAN 221.

The 5G network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221 via a wireless connection. The UE 210 can include one of a number of UEs not depicted that are in communication with the RAN 1120. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RU) 222 for wirelessly communicating with UE 210. The remote radio unit (RU) 222 can include a radio unit and may include one or more radio transceivers for wirelessly communicating with UE 210. The remote radio unit (RU) 222 may include circuitry for converting signals sent to and from an antenna of a Base Station into digital signals for transmission over packet networks. In some implementations, the RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The RAN 221 can include a new-generation radio access network (NG-RAN) that uses the 5G NR interface. In some embodiments, the distributed unit (DU) 224 and the centralized unit (CU) 227 of the RAN 221 may be co-located with the RU 222. In other embodiments, the DU 224 and the RU 222 may be co-located at a cell site and the centralized unit (CU) 227 may be located within a local data center (LDC). The DU 224 can include a logical node configured to provide functions for the radio link control (RLC) layer, the medium access control (MAC) layer, and the physical layer (PHY) layers. The CU 227 can be partitioned into a CU user plane portion (CU-UP) 226 and a CU control plane portion (CU-CP) 228. The CU-CP 228 may perform functions related to a control plane, such as connection setup, mobility, and security. The CU-UP 226 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228 can include a logical node configured to provide functions of the control plane part of the RRC and PDCP. The centralized unit for the user plane(CU-UP) 226 can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF), the session management function (SMF), and the user plane function (UPF). The AMF may act as a single-entry point for a UE connection and perform mobility management, registration management, and connection management between a data network and UE. The AMF may interface with the SMF to track user sessions. The AMF may interface with a network slice selection function (NSSF) to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and IP address allocation. The UPF may perform packet processing including routing and forwarding, quality of service (QoS) handling, and packet data unit (PDU) session management. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the data network to user equipment, via the RAN 221 and/or transfer uplink data received from user equipment to the data network via the RAN 221. An uplink can include a radio link though which user equipment transmits data and/or control signals to the RAN 221. A downlink can include a radio link through which the RAN 221 transmits data and/or control signals to the user equipment.

Uplink packets arriving from the RAN 221 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 221 and the UPF. The UPF may remove the packet headers belonging to the GTP tunnel before forwarding the user plane packets towards the data network. As the UPF may provide connectivity towards other data networks in addition to the data network, the UPF must ensure that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network are mapped onto a specific QoS flow belonging to a specific PDU session before forwarded towards the appropriate RAN 221. A QoS flow may correspond with a stream of data packets that have equal quality of service (QoS). The PDU session may utilize one or more quality of service (QoS) flows to exchange traffic (e.g., data and voice traffic) between the UE 210 and the data network. The one or more QoS flows can include the finest granularity of QoS differentiation within the PDU session. The PDU session may belong to a network slice instance through the 5G network 220. To establish user plane connectivity from the UE 210 to the data network, an AMF that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the radio access network (RAN) 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application’s environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In some implementations, to enable the communication between UE and base station, both UE and base station in the communication needs to reach agreement on the common configuration, such as using radio resource control (RRC) messages including system information type1 (SIB1) to reach agreement on configuration parameters. Referring to FIG. 2, to setup the initial connection between base station and UE 210, the base station may create a predefined synchronization signal and put the signal into a specific symbol in a specific subframe and broadcast to UE. The synchronization signal and the physical broadcast channel (PBCH) information can be packed as a single block that transmits together. The synchronization signal may include primary synchronization signal (PSS) and secondary synchronization signal (SSS). The PBCH information may include master information block (MIB) 261. MIB 261 may include the parameters that are required to decode system information type1 (SIB1) 263.

By using the information specified in the reference signal (e.g., SSB 331) broadcasted by the base station, the UE 210 can transmit a random access (physical random access channel (PRACH)) preamble 265 to request access to the 5G network 220. After the 5G network 220 receives the PRACH preamble 265, the 5G network 220 responds with random access response (RAR) 267 including an uplink grant that instructs the UE 210 on information to use for its subsequent uplink transmissions.

Using the initial uplink grant provided in RAR 267, the UE 210 may transmit a message 269 on the physical uplink shared channel (PUSCH) to the 5G network 220. PUSCH message 269 may carry a RRC setup request (e.g., RrcRequest) or just be pure user data. The 5G network 220 may transmit a RRC setup response 271, including a message on the physical uplink control channel (PUCCH) with an uplink grant, to the UE 210. Upon receiving the RRC setup response, the UE 210 may transmit a message 273 on the physical uplink shared channel (PUSCH), indicating the completeness of the RRC setup, to the 5G network 220.

In some implementations, the 5G network 220 may include a component to monitor the status of the network element or an element management system (EMS) 250. The EMS may manage one or more of a specific type of telecommunications network element, and may manage the functions and capabilities within each network element but does not manage the traffic between different network elements in the network. EMS is a centralized platform that enables real-time status monitoring and management of network connected elements or edge devices. For example, a system administrator can use an EMS to discover, deploy, and supervise the devices from a remote location. An EMS can also provide real-time data about any issues and network disruptions that may affect performance, enabling operators to diagnose and fix problems promptly, avoiding or greatly reducing downtime.

In some implementations, the EMS 250 may monitor one or more key performance indicators (KPIs) of the 5G network 220. The KPIs may include KPIs of base stations. In some implementations, the KPIs may further include KPIs of the core network functions. In some implementations, the KPIs may include peak data rates (e.g., downlink-20gbps, uplink-10gbps), data rate experienced by user (e.g., downlink-100mbps, uplink-50mbps), peak spectral efficiency (e.g. downlink-30 bits/sec/Hz, uplink-15bits/sec/Hz), average spectral efficiency (e.g., indoor hotspot – downlink 9/uplink 6.75, dense urban - downlink 7.8/ uplink 5.4, rural - downlink 3.3/ uplink 1.6), area traffic capacity (e.g., downlink-10Mbits/sec/m² in indoor hotspots), latency (user plane) (e.g., 4ms for enhanced mobile broadband (eMBB), 1ms for ultra-reliable low latency communications (URLLC)), connection density (e.g., 1 million devices/ km²), energy efficiency (such as efficient data transmission, low energy consumption) (e.g., 90% reduction in energy usage), reliability (e.g., 1 packet loss out of 100 million packets), mobility (e.g., dense urban – up to 30 kmph, rural – up to 500 kmph), mobility interruption time (e.g., 0ms), system bandwidth (e.g., at least 100 MHz, up to 1 GHz for operation in high-frequency bands above 6GHz), etc. In some implementations, the EMS 250 may monitor the KPIs by collecting data of KPIs at a predefined interval or in real time. In some implementations, the EMS 250 may generate a report regarding the KPIs periodically.

In some implementations, the EMS 250 may detect an error or failure when collecting the data of KPIs, such as missing data, or may fail to generate the report because of issues from data collection. In such situations, the EMS 250 may send a notification indicates an occurrence of an issue associated with the observability reporting, such as a potential failure of the KPI monitoring or reporting. In some implementations, the potential failure of the KPI monitoring or reporting may include source data issue due to system error or any other issue, EMS issue EMS connectivity issues, KPI reporting issues, data flow pipeline issue, intermittent data flow issue, etc.

The validation component 150 (150-1 or 150-2) may receive, from the EMS 250, the notification indicating an occurrence of an issue associated with the observability reporting. Upon receiving the notification, the validation component 150 (150-1 or 150-2) may trigger the observability validation process, which determines whether there exists an impact to user or customer caused by the issue associated with the observability reporting.

In some implementations, the observability validation process may include testing and obtaining call trace data and checking the call trace data to determine whether there exists an impact to customer caused by the potential failure of the KPI monitoring or reporting, which is described in detail below. In some implementations, the observability validation process may include obtaining packet capacity (PCap) log file and checking the PCap log file to determine whether there exists an impact to customer caused by the potential failure of the KPI monitoring or reporting, which is described in detail below, where the PCap log file may include the call flow messages that shows RRC and user traffic.

In some implementations, the validation component 150 (150-1 or 150-2) may implement the observability validation process by retrieving call trace data and determining whether one or more transmissions in the call trace data is incomplete. The call trace data may be data of a collection of transactions that represent a unique user or API transaction that is handled by an application and its constituent services. For example, when a user equipment (UE) sends an initial request to the network, a trace identifier may be assigned to a collection of data associated with each operation performed for responding and completing the initial request, together referred to as call trace data. In some implementations, the validation component 150 (150-1 or 150-2) may use end-to-end tracing tool or call-cause code viewer tool to obtain call trace data. The end-to-end tracing tool or call-cause code viewer tool may be a tool capable of providing probe functionality between NFs. Probe-based data associated with the probe functionality helps with comprehensive root cause analysis and requisite tracing to be captured. In some implementations, the validation component 150 (150-1 or 150-2) may determine whether at least one transaction toward a UE in the call trace data is incomplete (e.g., reflected by a flag, or a bit field). In some implementations, responsive to determining that at least one transaction toward a UE in the call trace data is incomplete, the validation component 150 (150-1 or 150-2) may determine that there exists an impact to one or more users caused by the issue associated with the observability reporting. In some implementations, responsive to determining that no transaction toward a UE in the call trace data is incomplete, the validation component 150 (150-1 or 150-2) may determine that there exists no impact to one or more users caused by the issue associated with the observability reporting.

In some implementations, the validation component 150 (150-1 or 150-2) may implement the observability validation process by retrieving call flow log and determining whether one or more transmissions in the call flow log is incomplete. The call flow data may be data of a set of ordered message transmissions between UE and base station, including cell search and downlink synchronization (e.g., message 261 or 263), uplink synchronization (e.g., message 265 or 267), radio resource control (RRC) connection request (e.g., message 269), RRC setup (e.g., message 271), and RRC setup complete (e.g., message 273). In some implementations, the validation component 150 (150-1 or 150-2) may download the packet capability (PCap) log file of a network element (e.g., CU or DU) to obtain call flow log. In some implementations, the validation component 150 (150-1 or 150-2) may determine whether at least one RRC setup complete message in the call flow log is specified as incomplete (e.g., reflected by a flag, or a bit field). In some implementations, responsive to determining that at least one RRC setup complete message in the call flow log is specified as incomplete, the validation component 150 (150-1 or 150-2) may determine that there exists an impact to one or more users caused by the issue associated with the observability reporting. In some implementations, responsive to determining that no RRC setup complete message in the call flow log is specified as incomplete, the validation component 150 (150-1 or 150-2) may determine that there exists no impact to one or more users caused by the issue associated with the observability reporting.

The validation component 150 (150-1 or 150-2) may send a validation result based on the determination to a corresponding component of the cellular network. In some implementations, responsive to determining that there exists an impact to one or more users caused by the issue associated with the observability reporting, the validation result may indicate that an action is required to mitigate or fix the issue associated with the observability reporting. In some implementations, responsive to determining that there exists no impact to one or more users caused by the issue associated with the observability reporting, the validation result may indicate that the issue associated with the observability reporting is a reporting issue.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a validation component (e.g., the validation component 150 of FIGS. 1-2).

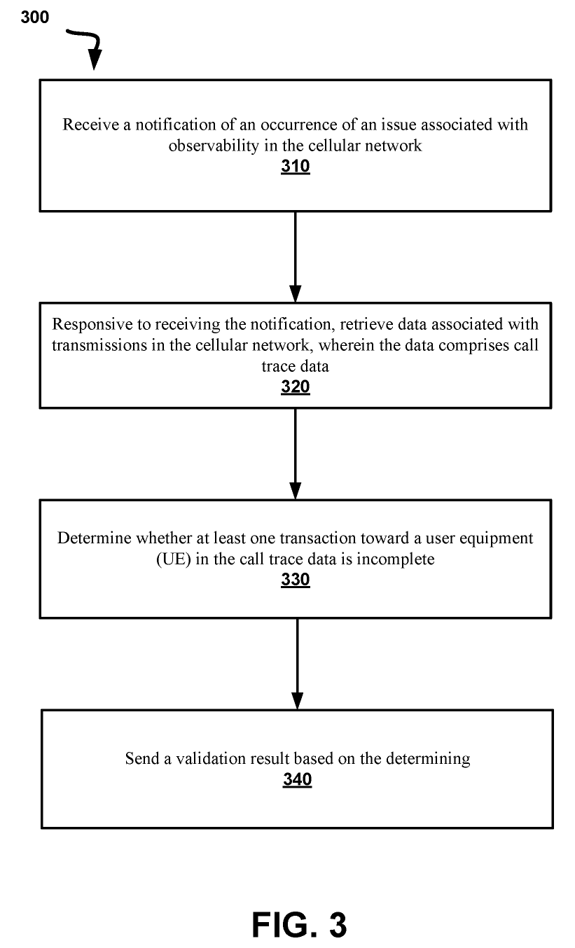

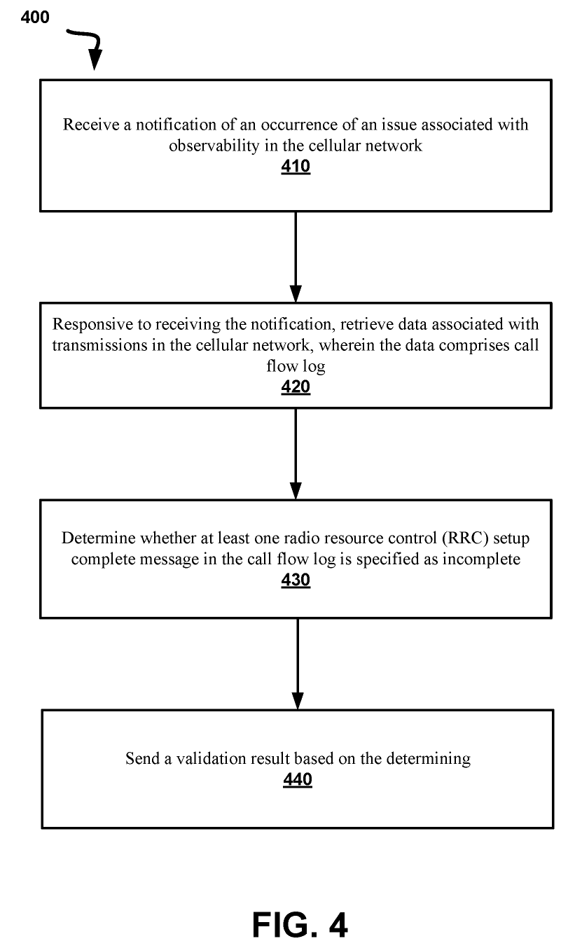

FIGS. 3 and 4 are flow diagrams of methods 300 and 400 of observability validation in a cellular network according to at least one embodiment. The methods 300 and 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 300 and 400 are performed by the system 100 of FIG. 1 or system 200 of FIG. 2. In one embodiment, the methods 300 and 400 are performed by the validation component 150 of FIGS. 1-2.

Referring to FIG. 3, at operation 310, the processing logic may receive a notification, where the notification indicates an occurrence of an issue associated with the observability reporting in the cellular network. In some implementations, the processing logic may receive the notification from a KPI monitoring component of the cellular network (e.g., vendor-specific EMS or performance monitoring tool, or EMS/monitor 250). In some implementations, the issue associated with the observability reporting may comprise at least one of: issue with source data due to the system error, issue with element management system (EMS) itself, EMS connectivity issue, reporting issue, data flow pipeline issue (in case of O-RAN and cloud network), or intermittent data flow issue (e.g., from EMS to network monitoring tool). In some implementations, the notification is received from a component that monitors one or more key performance indicators (KPIs). In some implementations, the one or more KPIs are associated with a distributed unit (DU) or a centralized unit (CU) of the O-RAN.

At operation 320, responsive to receiving the notification, the processing logic may retrieve data associated with transmissions in the cellular network, wherein the data comprises call trace data. In some implementations, the call trace data comprises a trace identifier. In some implementations, the processing logic may retrieve the call trace data from an end-to-end tracing tool or a call-cause code viewer tool.

At operation 330, the processing logic may determine whether one or more transmissions in the call trace data is incomplete. In some implementations, the processing logic may determine whether at least one transmission in the call trace data is incomplete by determining whether at least one transaction toward a user equipment (UE) in the call trace data is incomplete. In some implementations, the processing logic may determine whether at least one transaction toward a user equipment (UE) in the call trace data is incomplete by checking a flag or a bit field in the call trace data. In some implementations, responsive to determining that at least one transaction toward a UE in the call trace data is incomplete, the processing logic may determine that there exists an impact to one or more users caused by the issue associated with the observability reporting. In some implementations, responsive to determining that no transaction toward a UE in the call trace data is incomplete, the processing logic may determine that there exists no impact to one or more users caused by the issue associated with the observability reporting.

At operation 340, the processing logic may send a validation result based on the determining. In some implementations, responsive to determining that there exists an impact to one or more users caused by the issue associated with the observability reporting, the validation result indicates that an action is required to mitigate or fix the issue associated with the observability reporting. In some implementations, responsive to determining that there exists no impact to one or more users caused by the issue associated with the observability reporting, the validation result indicates that the issue associated with the observability reporting is a reporting issue.

Referring to FIG. 4, at operation 410, the processing logic may receive a notification that indicates an occurrence of an issue associated with the observability reporting in the cellular network, which may be similar to or same as the operation 310.

At operation 420, responsive to receiving the notification, the processing logic may retrieve data associated with transmissions in the cellular network, wherein the data comprises call flow log. In some implementations, the processing logic may retrieve the call flow log by downloading a packet capability (PCap) log file of a network element (e.g., CU or DU).

At operation 430, the processing logic may determine whether one or more transmissions in the call flow log is incomplete. In some implementations, the processing logic may determine whether at least one transmission in the call flow log is incomplete by determining whether at least one RRC setup complete message in the call flow log is specified as incomplete. In some implementations, the processing logic may determine whether at least one RRC setup complete message in the call flow log is specified as incomplete by checking a flag or a bit field in the call flow log. In some implementations, responsive to determining that at least one RRC setup complete message in the call flow log is specified as incomplete, the processing logic may determine that there exists an impact to one or more users caused by the issue associated with the observability reporting. In some implementations, responsive to determining that no RRC setup complete message in the call flow log is specified as incomplete, the processing logic may determine that there exists no impact to one or more users caused by the issue associated with the observability reporting.

At operation 440, the processing logic may send a validation result based on the determining, which may be similar to or same as the operation 340.

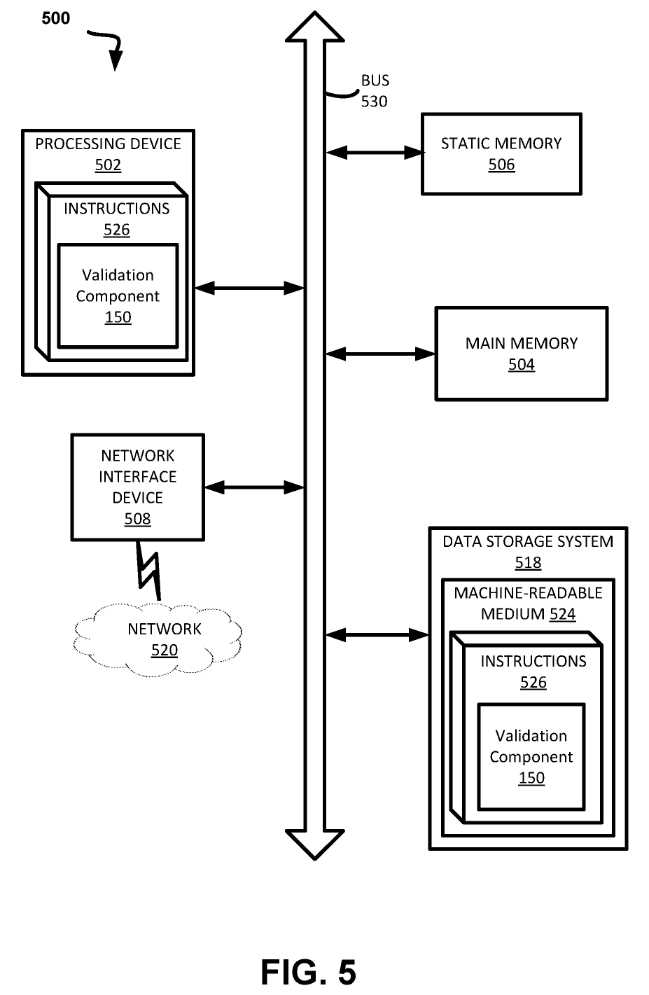

FIG. 5 illustrates an example machine of a computer system 500 within which a set of instructions, for causing the machine to perform any one or more of the methodologies discussed herein, can be executed. In some embodiments, the computer system 500 can be used to perform the operations of a controller (e.g., to execute an operating system to perform operations corresponding to the validation component 150 of FIGS. 1-2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520. The network 520 may correspond to the cellular network 120 of FIG. 1, or the 5G network 220 of FIG. 2.

The data storage system 518 can include a machine-readable storage medium 524 (also known as a computer-readable medium or a non-transitory computer-readable storage medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The processing device 502, the network interface 508, and the network 520 can correspond to the system 100 of FIG. 1, or the system 200 of FIG. 2.

In one embodiment, the instructions 526 include instructions to implement functionality corresponding to the validation component 150 of FIGS. 1-2. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of observability validation in an open radio access network (O-RAN) of a cellular network, the method comprising:
receiving a notification of an occurrence of an issue associated with observability reporting in the cellular network;
responsive to receiving the notification, retrieving data associated with transmissions in the cellular network;
determining whether at least one transmission in the data is incomplete; and
sending a validation result based on the determining.

2. The method of claim 1, wherein the data comprises call trace data, and wherein determining whether the at least one transmission in the data is incomplete comprises determining whether at least one transaction toward a user equipment (UE) in the call trace data is incomplete.

3. The method of claim 1, wherein the data comprises call flow log, and wherein determining whether the at least one transmission in the data is incomplete comprises determining whether at least one radio resource control (RRC) setup complete message in the call flow log is specified as incomplete.

4. The method of claim 1, wherein responsive to determining that there exists a user impact caused by the issue associated with the observability reporting, the validation result indicates that an action is required to mitigate or fix the issue associated with the observability reporting.

5. The method of claim 1, wherein responsive to determining that there exists no user impact caused by the issue associated with the observability reporting, the validation result indicates that the issue associated with the observability reporting is a reporting issue.

6. The method of claim 1, wherein the notification is received from a component that monitors one or more key performance indicators (KPIs).

7. The method of claim 6, wherein the one or more KPIs are associated with a distributed unit (DU) or a centralized unit (CU) of the O-RAN.

8. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
receiving a notification of an occurrence of an issue associated with observability reporting in the cellular network;
responsive to receiving the notification, retrieving data associated with transmissions in the cellular network;
determining whether at least one transmission in the data is incomplete; and
sending a validation result based on the determining.

9. The computing system of claim 8, wherein the data comprises call trace data, and wherein determining whether the at least one transmission in the data is incomplete comprises determining whether at least one transaction toward a user equipment (UE) in the call trace data is incomplete.

10. The computing system of claim 8, wherein the data comprises call flow log, and wherein determining whether the at least one transmission in the data is incomplete comprises determining whether at least one radio resource control (RRC) setup complete message in the call flow log is specified as incomplete.

11. The computing system of claim 8, wherein responsive to determining that there exists a user impact caused by the issue associated with the observability reporting, the validation result indicates that an action is required to mitigate or fix the issue associated with the observability reporting.

12. The computing system of claim 8, wherein responsive to determining that there exists no user impact caused by the issue associated with the observability reporting, the validation result indicates that the issue associated with the observability reporting is a reporting issue.

13. The computing system of claim 8, wherein the notification is received from a component that monitors one or more key performance indicators (KPIs).

14. The computing system of claim 13, wherein the one or more KPIs are associated with a distributed unit (DU) or a centralized unit (CU) of an open radio access network (O-RAN) of the cellular network.

15. One or more non-transitory, computer-readable storage media having computer-readable instructions thereon which, when executed by one or more processing devices, cause the one or more processing devices to perform operations comprising:
receiving a notification of an occurrence of an issue associated with observability reporting in a cellular network;
responsive to receiving the notification, retrieving data associated with transmissions in the cellular network;
determining whether at least one transmission in the data is incomplete; and
sending a validation result based on the determining.

16. The one or more non-transitory, computer-readable storage media of claim 15, wherein the data comprises call trace data, and wherein determining whether the at least one transmission in the data is incomplete comprises determining whether at least one transaction toward a user equipment (UE) in the call trace data is incomplete.

17. The one or more non-transitory, computer-readable storage media of claim 15, wherein the data comprises call flow log, and wherein determining whether the at least one transmission in the data is incomplete comprises determining whether at least one radio resource control (RRC) setup complete message in the call flow log is specified as incomplete.

18. The one or more non-transitory, computer-readable storage media of claim 15, wherein responsive to determining that there exists a user impact caused by the issue associated with the observability reporting, the validation result indicates that an action is required to mitigate or fix the issue associated with the observability reporting.

19. The one or more non-transitory, computer-readable storage media of claim 15, wherein responsive to determining that there exists no user impact caused by the issue associated with the observability reporting, the validation result indicates that the issue associated with the observability reporting is a reporting issue.

20. The one or more non-transitory, computer-readable storage media of claim 15, wherein the notification is received from a component that monitors one or more key performance indicators (KPIs), and wherein the one or more KPIs are associated with a distributed unit (DU) or a centralized unit (CU) of an open radio access network (O-RAN) of the cellular network.
